(19) United States
(12) Patent Application Publication
(10) Pub. No.: US 2013/0147882 A1
(43) Pub. Date: Jun. 13, 2013

(54) Liquid Ejecting Head and Liquid Ejecting Apparatus

(71) Applicant: Seiko Epson Corporation, Tokyo (JP)

(72) Inventors: Hiroaki Okui, Nagano-ken (JP); Shunsuke Watanabe, Nagano-ken (JP)

(73) Assignee: SEIKO EPSON CORPORATION, Tokyo (JP)

(21) Appl. No.: 13/687,325

(22) Filed: Nov. 28, 2012

(30) Foreign Application Priority Data
Dec. 13, 2011 (JP) 2011-272045

(51) Int. Cl. B41J 2/14

(52) U.S. Cl. CPC B41J 2/1433
USPC 347/71

(57) ABSTRACT

A liquid ejecting head includes a retention member with a liquid inlet path, a liquid ejecting head main body configured to dispense liquid droplets through a nozzle, and a fixing plate to which the liquid ejecting head main body is fixed. The fixing plate includes a first joint portion to which the nozzle surface is attached, and a second joint portion to which the retention member is attached. The retention member includes a head chamber. Portions of the retention member and the liquid ejecting head main body around the liquid inlet path and the liquid flow path are bonded, the liquid ejecting head main body being attached to the first joint portion via the nozzle surface and accommodated in the head chamber, and the second joint portion and a periphery of the opening of the head chamber in the retention member are attached to each other.

This application claims a priority to Japanese Patent Application No. 2011-272045 filed on Dec. 13, 2011 which is hereby expressly incorporated by reference herein in its entirety.

### BACKGROUND

1. Technical Field

The present invention relates to a liquid ejecting head and a liquid ejecting apparatus, configured so as to generate pressure fluctuation in a pressure chamber communicating with nozzles, to thereby eject a liquid in the pressure chamber through the nozzles.

2. Related Art

The liquid ejecting head can be typically exemplified by an ink jet recording head (hereinafter, simply recording head) employed in an image recording apparatus such as an ink jet recording apparatus, and the recording head has come to be widely applied to various manufacturing apparatuses because of the advantage that a minute amount of liquid can be made to accurately land on a predetermined position. Examples of such manufacturing apparatuses include a display manufacturing apparatus for manufacturing color filters for a liquid crystal display and the like, an electrode forming apparatus for manufacturing electrodes for an organic electroluminescence (EL) display or a field emission display (FED), and a chip manufacturing apparatus for manufacturing biochips (biochemical elements). The recording head for the image recording apparatus is configured to eject liquid ink, and a color material ejecting head for the display manufacturing apparatus is configured to eject a solution of a color such as red (R), green (G), or blue (B). An electrode material ejecting head for the electrode forming apparatus is configured to eject an electrode material in a liquid phase, and a bioorganic ejecting head of the chip manufacturing apparatus is configured to eject a bioorganic solution.

An example of the aforementioned recording head is shown in FIG. 6, which includes a plurality of recording head main bodies 89 that eject (dispense) the ink, attached to a retention member 90, for example as disclosed in JP-A-2010-240856. The retention member 90 includes liquid inlet paths 91 provided therethrough, so that upon mounting thereon an ink cartridge loaded with ink, the ink can be introduced into the respective recording head main bodies 89 through the liquid inlet path 91. The recording head main bodies 89 each include therein, as shown in FIG. 7, a liquid flow path 92 having an end portion communicating with the liquid inlet path 91, a pressure chamber 94 communicating with the other end portion of the liquid flow path 92 through a common liquid chamber 93, and a piezoelectric actuator 95 that generates pressure fluctuation in the pressure chamber 94. In addition, the pressure chamber 94 communicates with a nozzle 97 having an opening on a nozzle surface 96. With such a configuration, when the piezoelectric actuator 95 is driven so as to generate pressure fluctuation in the pressure chamber 94, the ink droplet is ejected (dispensed) through the nozzle 97.

The recording head main bodies 89 are each bonded to the retention member 90 via the face opposite the nozzle surface 96. To be more detailed, an adhesive 99 is provided around the position where the liquid inlet path 91 and the liquid flow path 92 are located, so as to form a junction therebetween. In addition, a fixing plate 98 having openings for exposing the nozzles 97 therethrough is attached to the nozzle surface 96 of the recording head main body 89. The fixing plate 98 serves to define the relative positional relationship between the plurality of recording head main bodies 89, and is attached only to the nozzle surface 96 of each recording head main body 89, and not to the retention member 90.

The foregoing recording head main body 89 is composed of a plurality of substrates stacked on each other, and hence the fluctuation in size within a manufacturing tolerance may be accumulated to be larger and the height of the recording head main bodies 89 may become different. Accordingly, the retention member 90 and the recording head main body 89 are coupled to each other with a certain gap therebetween, taking the fluctuation in height among the recording head main bodies 89 into account. The thickness of the adhesive 99 provided in the gap can absorb the fluctuation in height among the recording head main bodies 89. However, because of the considerable thickness of the adhesive 99, the adhesive 99 is exposed to the ambient air, which leads to the drawback in that water contained in the ink located in the junction between the liquid inlet path 91 and the liquid flow path 92 evaporates through the adhesive 99, and the viscosity of the ink is increased. In addition, the adhesion strength of the recording head main body 89 declines with an increase in thickness of the adhesive 99 provided between the retention member 90 and the recording head main body 89. Further, a jig or the like has to be employed for adjusting the gap between the retention member 90 and the recording head main body 89, which is a factor that degrades the manufacturing efficiency.

### SUMMARY

An advantage of some aspects of the invention is that a liquid ejecting head and a liquid ejecting apparatus are provided that prevent evaporation of water through the bonding interface between a retention member and a liquid ejecting head main body, and allows positional management of a nozzle surface of the liquid ejecting head main body to be performed with ease, and the adhesion strength between the retention member and the liquid ejecting head main body to be increased.

In an aspect, the invention provides a liquid ejecting head including a retention member with a liquid inlet path formed therein so as to introduce a liquid from a liquid storage unit, a liquid ejecting head main body configured to introduce the liquid into a pressure chamber through a liquid flow path communicating with the liquid inlet path and to dispense droplets of the liquid in the pressure chamber through a nozzle formed on a nozzle surface, and a fixing plate to which the liquid ejecting head main body is fixed. The fixing plate includes a first joint portion to which the nozzle surface of the liquid ejecting head main body is attached, and a second joint portion provided on an outer side of the joint interface between the fixing plate and the nozzle surface in the first joint portion and to which the retention member is attached. The first joint portion includes an opening region through which the nozzle on the nozzle surface of the liquid ejecting head main body is exposed, and a joint region provided around the opening region and attached to a part of the nozzle surface. The retention member includes a head chamber formed so as to recede from the joint interface with the fixing plate in a direction opposite the fixing plate. The retention member and the liquid ejecting head main body are bonded to each other via the respective portions thereof around the liquid inlet path and the liquid flow path, the liquid ejecting head main body being attached to the first joint portion of the fixing plate via the nozzle surface and accommodated in the head chamber, and the second joint portion of the fixing plate and a periphery of the opening of the head chamber of the retention member are attached to each other.

With the liquid ejecting head thus configured, the liquid ejecting head main body is accommodated in the head chamber, and the space between the opening of the head chamber and the nozzle surface is closed by the fixing plate. Accordingly, the junction between the liquid inlet path and the liquid flow path is tightly sealed with both the adhesive provided around the junction and the fixing plate. Such a configuration prevents evaporation of water from the junction, to thereby suppress an increase in viscosity of the liquid in the liquid ejecting head. In addition, the liquid ejecting head main body is bonded to the retention member and also the fixing plate, to which the nozzle surface of the liquid ejecting head main body is attached, is attached to the retention member, and therefore the adhesion strength between the retention member and the liquid ejecting head main body can be increased. Further, there is no need to increase the thickness of the adhesive between the nozzle surface and the fixing plate to an excessive level and therefore the position in height direction (perpendicular to the nozzle surface) of the nozzle surface of the liquid ejecting head main body attached to the fixing plate is uniquely determined, and since the retention member is directly attached to the fixing plate, the position of the liquid ejecting head main body, in particular the position of the nozzle surface in the height direction is determined on the basis of the height of the joint interface between the fixing plate and the nozzle surface and the height of the retention member, irrespective of the height of the liquid ejecting head main body. Such a configuration allows the position of the nozzle surface of the liquid ejecting head main body in the height direction to be easily managed utilizing the joint interface between the fixing plate and the liquid ejecting head main body as a reference plane, without the need to employ a jig or the like. Consequently, positional fluctuation of the nozzle surface in the height direction among the liquid ejecting head main bodies can be suppressed.

Preferably, the first joint portion and the second joint portion may be disposed on the same plane.

Such a configuration further facilitates the management of the position of the nozzle surface of the liquid ejecting head main body, and more effectively suppresses the positional fluctuation of the nozzle surface in the height direction among the liquid ejecting head main bodies.

In another aspect, the invention provides a liquid ejecting apparatus that includes the foregoing liquid ejecting head.

### BRIEF DESCRIPTION OF THE DRAWINGS

The invention will be described with reference to the accompanying drawings, wherein like numbers reference like elements.

FIG. 1 is a perspective view showing a configuration of a printer.

FIG. 2 is an exploded perspective view of a recording head.

FIG. 3 is a cross-sectional view of the recording head.

FIG. 4 is a cross-sectional view taken along a line IV-IV in FIG. 3.

FIG. 5 is an enlarged view of a portion marked as V in FIG. 3.

FIG. 6 is a cross-sectional view of a conventional recording head.

FIG. 7 is an enlarged view of a portion marked as VII in FIG. 6.

### DESCRIPTION OF EXEMPLARY EMBODIMENTS

Hereafter, an embodiment of the invention will be described with reference to the drawings. Although various limitations are given in the following embodiment as preferred examples of the invention, the scope of the invention is in no way limited to the embodiment unless otherwise specifically noted. In the following description, the liquid ejecting apparatus according to the invention will be exemplified by an ink jet printer 1.

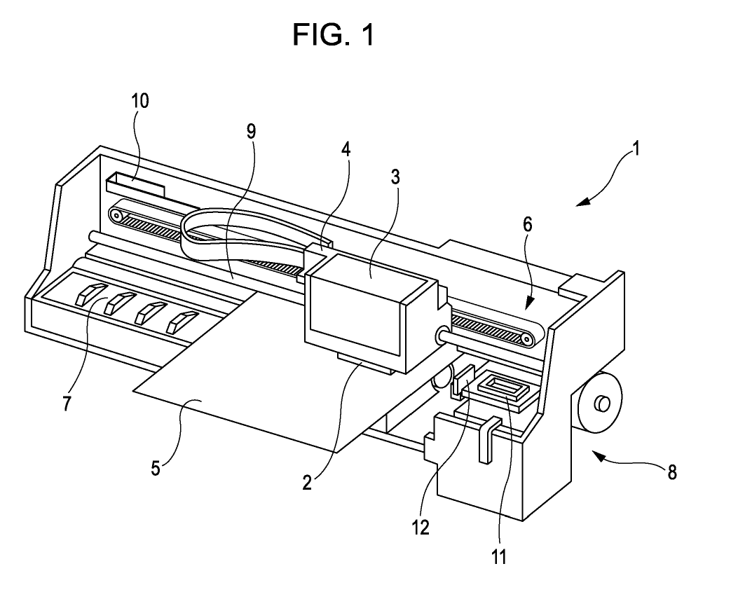

FIG. 1 is a perspective view showing a configuration of the ink jet printer (hereinafter, simply printer) 1. The printer 1 includes thereinside an ink jet recording head (hereinafter, simply recording head) 2, exemplifying the liquid ejecting head, and a carriage 4 in which an ink cartridge 3 containing a liquid, exemplifying the liquid storage unit, is removably placed. At the rear of the carriage 4, a carriage moving mechanism 6 is provided so as to make the carriage 4 to reciprocate in a width direction of a recording paper 5 (an example of recording media and the landing target of the liquid), in other words in a main scanning direction. In addition, a platen 7 is provided under the recording head 2, in a region corresponding to the recording stroke thereof. The recording paper 5 is transported over the platen 7 in a sub scanning direction orthogonal to the main scanning direction, by a transport mechanism 8 provided on the back of the printer 1.

The carriage 4 is pivotally supported by a guide rod 9 installed in the main scanning direction, and driven by the carriage moving mechanism 6 so as to move in the main scanning direction along the guide rod 9. The position of the carriage 4 in the main scanning direction is detected by a linear encoder 10, an example of position information detectors, which transmits the detection signal, specifically an encoder pulse (an example of the position information), to a control unit of the printer 1.

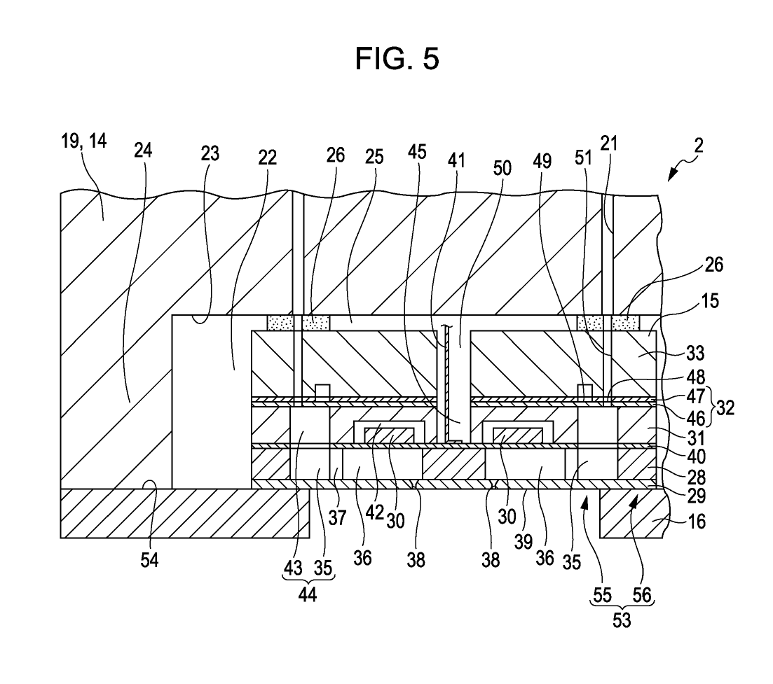

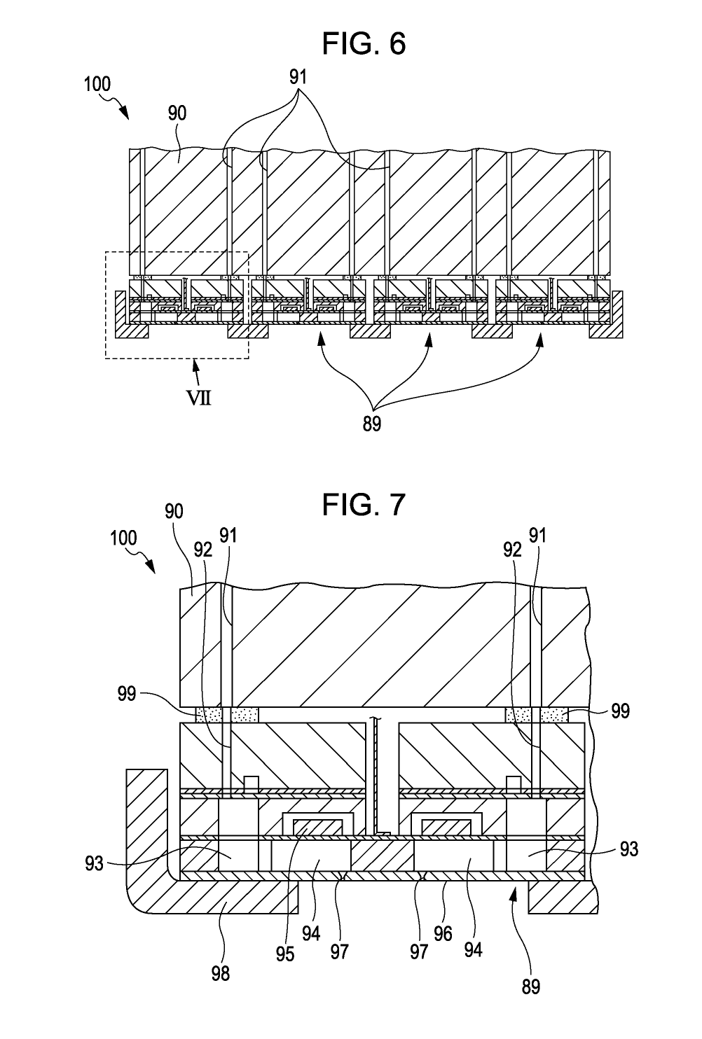

Further, a home position serving as the initial point of the scanning action of the carriage 4 is provided on an end portion of the travelling range thereof, outside the recording region. In this embodiment, a cap 11 that covers a nozzle surface 39 (see nozzle plate 29 in FIG. 5) of the recording head 2 and a wiper 12 that cleans the surface where the nozzles are provided are provided in the home position. The printer 1 is configured so as to perform bidirectional recording, in which characters and images are recorded on the recording paper 5 both when the carriage 4 moves forward from the home position toward the opposite end and when the carriage 4 moves backward from the opposite end to the home position.

The recording head 2 will now be described referring to the drawings.

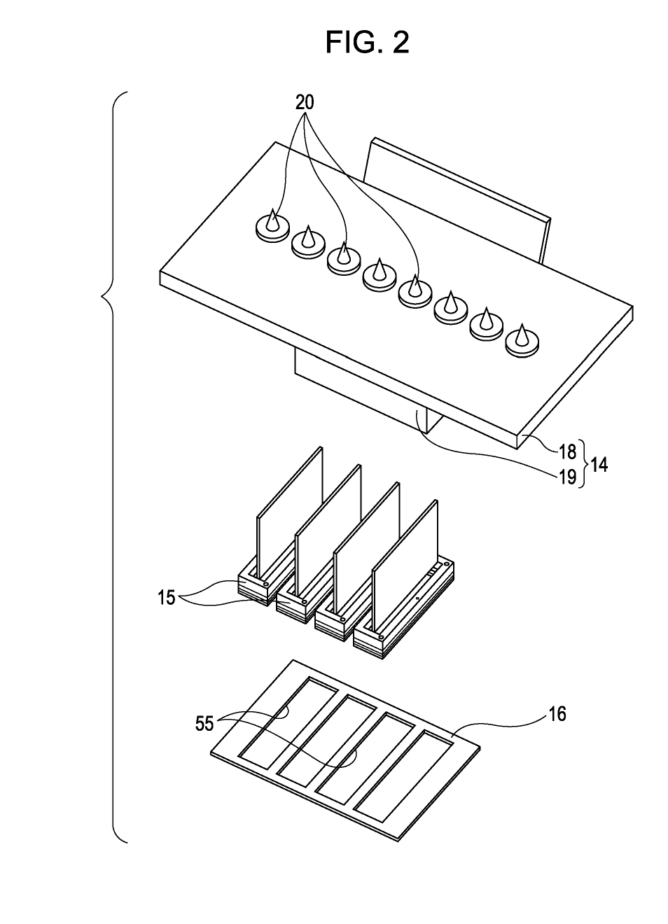

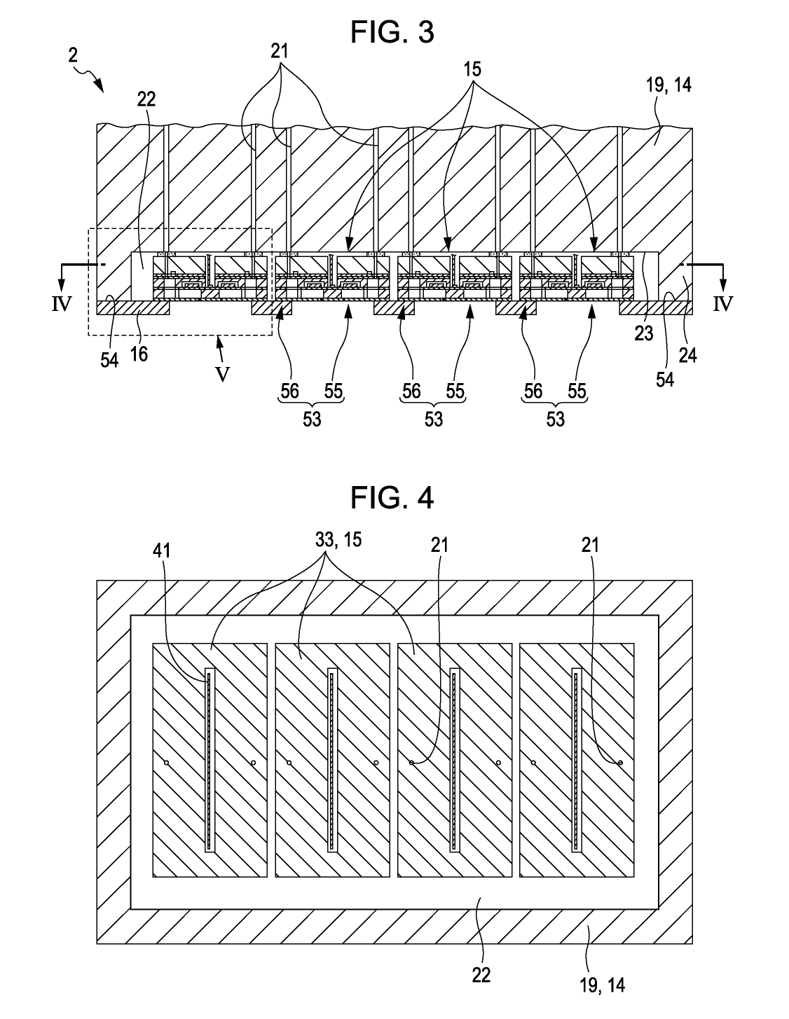

FIG. 2 is an exploded perspective view of the recording head 2 according to this embodiment. FIG. 3 is a cross-sectional view of the recording head 2. FIG. 4 is a cross-sectional view taken along a line IV-IV in FIG. 3. FIG. 5 is an enlarged view of a portion marked as V in FIG. 3. The recording head 2 according to this embodiment includes a holder 14 exemplifying the retention member, a plurality of recording head main bodies 15 each exemplifying the liquid ejecting head main body, and a fixing plate 16. In the recording head 2, four recording head main bodies 15 are aligned with a clearance therebetween, and fixed to the fixing plate 16.

The holder 14 includes a cartridge mounting base 18 on which the ink cartridge 3 is mounted and a head enclosure 19 provided under the cartridge mounting base 18 and in which the recording head main bodies 15 are accommodated. A plurality of liquid inlet needles 20 are provided on the cartridge mounting base 18 so as to project upward, i.e., toward the ink cartridge 3. In addition, as shown in FIG. 3, liquid inlet paths 21 are provided inside the holder 14, for communication between a corresponding ink inlet needle and a head chamber 22 (described later) in the head enclosure 19 through inside the cartridge mounting base 18. The lower end portion of each liquid inlet path 21 is open in the head chamber 22 at the position corresponding to a case flow path 51 to be subsequently described. When the ink cartridge 3 is mounted on the recording head 2, the liquid inlet needles 20 are inserted into the ink cartridge 3. Accordingly, the ink stored in the ink cartridge 3 is introduced into the recording head main bodies 15 through the liquid inlet paths 21.

The head enclosure 19 includes the head chamber 22 formed so as to recede from the lower end face (to be attached to the fixing plate 16) toward the cartridge mounting base 18 (opposite the fixing plate 16). The plurality (four in this embodiment) of recording head main bodies 15 are accommodated inside the head chamber 22. In other words, the head enclosure 19 includes a head mounting surface 23 formed on a lower face thereof and on which the recording head main bodies 15 are attached, and a wall portion 24 extending downward (toward the fixing plate 16) from an outer peripheral portion of the head mounting surface 23. The space defined by the head mounting surface 23 and the wall portion 24 constitutes the head chamber 22. The lower end portion of each liquid inlet path 21 is open in the head mounting surface 23.

In this embodiment, the wall portion 24 is set to be slightly higher than the designed height of the recording head main body 15, so that the recording head main bodies 15 can be accommodated inside the head chamber 22 despite a difference in height among the recording head main bodies 15 (see FIG. 5). Accordingly, when the recording head main bodies 15 are placed in the head chamber 22 a narrow gap 25 is defined between the upper face of each recording head main body 15 and the head mounting surface 23. An adhesive 26 is provided in a region of the gap 25 at the position corresponding to the liquid inlet path 21 and the case flow path 51, so as to bond the upper face of each recording head main body 15 and the head mounting surface 23 together. Alternatively, a spacer may be provided along the lower opening edge of the liquid inlet path 21 or the upper opening edge of the case flow path 51, and the communication between the liquid inlet path 21 and the case flow path 51 may be established by abutting the spacer to the opposing surface. In this case, the adhesive is provided around the spacer. In this embodiment, further, a space is provided between the four recording head main bodies 15 in the head chamber 22 and the wall portion 24, as shown in FIG. 4.

The recording head main body 15 will now be described hereunder.

As shown in FIG. 5, the recording head main bodies 15 each include a flow path plate 28, a nozzle plate 29, a piezoelectric actuator 30 (an example of pressure generators), a cover plate 31, a compliance substrate 32, and a head case 33.

The flow path plate 28 is formed of a slender monocrystalline silicon substrate extending along a nozzle row, and includes a pair of slender communication path 35 extending in the longitudinal direction of the flow path plate 28. In the region between the pair of communication path 35, two rows of pressure chambers 36, in each of which the pressure chambers 36 are aligned along the nozzle row, are provided so as to respectively correspond to the communication path 35. Each of the pressure chambers 36 communicate with the communication path 35 through an ink supply path 37 narrower than the pressure chamber 36.

The nozzle plate 29 is attached to the lower face of the flow path plate 28 (opposite the piezoelectric actuator 30) with an adhesive, a hot-melt film, or the like therebetween. The nozzle plate 29 is formed of a stainless steel or monocrystalline silicon, and perforated with a plurality of nozzles 38 each communicating with the corresponding pressure chamber 36 on the side opposite the ink supply path 37. The nozzles 38 constitute the nozzle row aligned in a pitch of, for example, 360 dpi. Here, the lower surface of the nozzle plate 29 corresponds to the nozzle surface 39 according to the invention. The fixing plate 16 is attached to the periphery of the nozzle surface 39.

An elastic film 40 is stacked on the upper face of the flow path plate 28 (opposite the nozzle plate 29). On the elastic film 40, two rows of piezoelectric actuators 30 are aligned so as to each oppose the corresponding pressure chamber 36, each piezoelectric actuator 30 including a lower electrode layer, a piezoelectric layer, and an upper electrode layer stacked in this order. An end portion of the piezoelectric actuator 30 on the side of the center of the recording head main body 15 is connected to a lead electrode (not shown) for electrical connection with the upper electrode layer. The other end portion of the lead electrode extends on an insulating layer to a position corresponding to the center of the recording head main body 15, and is electrically connected to an end portion of a flexible cable 41. The other end portion of the flexible cable 41 is connected to the control unit which is not shown.

In addition, a cover plate 31 is attached to the elastic film 40 at the position corresponding to the piezoelectric actuator 30, the cover plate 31 including a piezoelectric actuator chamber 42 of a size that allows the piezoelectric actuator 30 to vibrate undisturbed. The cover plate 31 also includes a pair of reservoir portions 43 of a slender shape, each formed at the position corresponding to one of the communication path 35, and a routing space 45 provided in the central portion of the recording head main body 15 to allow the connection between the flexible cable 41 and the lead electrode. The reservoir portions 43 each communicate with one of the communication path 35, and constitute a reservoir (common liquid chamber) 44 that supplies the ink to the pressure chamber 36.

The compliance substrate 32 includes a sealing layer 46 of a flexible material and a fixing substrate 47 of a hard material such as a metal layered on each other, and is attached to the upper face of the cover plate 31 (opposite the flow path plate 28). The compliance substrate 32 includes an ink inlet 48 formed so as to penetrate therethrough in the thickness direction, to introduce the ink into the reservoir 44. In addition, the fixing substrate 47 is removed from the region of the compliance substrate 32 opposing the reservoir 44 except for the ink inlet 48, so that a sealing portion 49 solely formed of the sealing layer 46 is provided. Accordingly, the reservoir 44 is sealed with the flexible sealing portion 49, and thus the compliance can be secured.

The head case 33 is a hollow box-shaped member attached to the upper face of the compliance substrate 32 (opposite the cover plate 31). The head case 33 includes therein an insertion space 50 communicating with the routing space 45 of the cover plate 31, and the case flow path 51 formed so as to penetrate therethrough in the height direction. The flexible cable 41 is inserted through the insertion space 50. The case flow path 51 serves to supply the ink from the side of the holder 14 to the reservoir 44, and has the upper end portion communicating with the liquid inlet path 21 and the lower end portion communicating with the ink inlet 48. The head case 33 also includes a sealing space of a size that does not disturb the flexible deformation of the sealing layer 46, located on the lower face of the head case 33 at the position corresponding to the sealing portion 49.

The ink from the ink cartridge 3 is introduced into the case flow path 51 through the liquid inlet path 21. The ink introduced into the case flow path 51 is supplied to the pressure chamber 36 through the reservoir 44 and the ink supply path 37. Upon activating the piezoelectric element at this stage, the ink in the pressure chamber 36 is subjected to pressure fluctuation. Then the ink is ejected through the nozzle 38 utilizing the pressure fluctuation. Here, the series of flow paths composed of the case flow path 51, the ink inlet 48, the reservoir 44, and the ink supply path 37 correspond to the liquid flow path according to the invention.

Hereunder, the fixing plate 16 will be described.

Referring to FIG. 2, the fixing plate 16 is a flat plate made of a stainless steel or the like. The fixing plate 16 includes, for example as shown in FIG. 3, first joint portions 53 to each of which the nozzle surface 39 of the recording head main body 15 is attached, and a second joint portion 54 to which the holder 14 (wall portion 24) is attached, the second joint portion 54 being located on an outer side of the position where the first joint portions 53 are attached to the nozzle surface 39. The first joint portion 53 each include an opening region 55 through which the nozzles 38 in the nozzle surface 39 of the recording head main body 15 are exposed, and a joint region 56 located around the opening regions 55 so as to be attached to a part of the nozzle surface 39.

In this embodiment, the fixing plate 16 is formed such that the shape of the outer periphery thereof fits that of the lower end face of the head enclosure 19 (wall portion 24) in a plan view, so that the outer surfaces of the head enclosure 19 and the fixing plate 16 becomes flush with each other upon attaching the second joint portion 54 to the lower end face of the holder 14. Thus, the outer peripheral portion of the fixing plate 16 constitutes the second joint portion 54. In this embodiment, in addition, the four recording head main bodies 15 are aligned with a spacing therebetween and fixed to the fixing plate 16, and hence the fixing plate 16 includes four opening regions 55 aligned in the direction orthogonal to the nozzle row. The opening regions 55 are each formed so as to penetrate through the fixing plate 16 in the thickness direction thereof, in a size that allows at least all the nozzles 38 in the nozzle surface 39 to be exposed. The portion of the periphery of the opening regions 55 that is attached to the periphery of the nozzle surface 39 of the respective recording head main bodies 15 constitutes the joint region 56. In this embodiment, the first joint portions 53 and the second joint portion 54 are disposed on the same plane.

To assemble the recording head 2, first the recording head main bodies 15 are each attached to the first joint portion 53 of the fixing plate 16 such that the nozzles 38 are exposed through the opening region 55. In this process, an adhesive is applied to the joint regions 56 of the fixing plate 16, and the nozzle surfaces 39 of the respective recording head main bodies 15 are pressed against the joint regions 56 for bonding. At this stage, the joint regions 56 and the nozzle surface 39 are bonded together, substantially in tight contact with each other. Accordingly, the nozzle surfaces 39 of the recording head main bodies 15 attached to the fixing plate 16 are located at the same level in the height direction (perpendicular to the nozzle surface 39). Here, the second and subsequent recording head main bodies 15 to be attached to the fixing plate 16 are aligned with respect to the first joint portion 53 of the fixing plate, such that the nozzles 38 of the respective recording head main bodies 15 are located at the desired positions, utilizing the position of the nozzles 38 of the first-attached recording head main body 15 as the reference. Such an arrangement allows the relative positional accuracy among the recording head main bodies 15 on the fixing plate 16 to be secured.

Then the fixing plate 16, now bonded with the four recording head main bodies 15, is attached to the holder 14. To be more detailed, the recording head main bodies 15 are each accommodated inside the head chamber 22 and the upper face of the recording head main bodies 15 and the head mounting surface 23 are bonded together via the adhesive 26, and the second joint portion 54 of the fixing plate 16 is attached to the periphery of the opening of the head chamber 22 of the holder 14 (lower end face of the wall portion 24), via an adhesive. In this embodiment, since the first joint portions 53 and the second joint portion 54 are disposed on the same plane, the nozzle surfaces 39 of the recording head main bodies 15 and the periphery of the opening of the head chamber 22 of the holder 14 (lower end face of the wall portion 24) are also disposed on the same plane.

As described above, the recording head main bodies 15 are accommodated in the head chamber 22 and the space between the opening of the head chamber 22 and the nozzle surface 39 is closed by the fixing plate 16. Accordingly, the junction between the liquid inlet path 21 and the case flow path 51 is tightly sealed with both the adhesive 26 provided around the junction and the fixing plate 16. Such a configuration prevents evaporation of water from the junction, to thereby suppress an increase in viscosity of the ink in the recording head 2. In addition, the recording head main bodies 15 are bonded to the holder 14, and also the fixing plate 16 to which the recording head main bodies 15 are attached is attached to the holder 14, and therefore the adhesion strength between the holder 14 and the recording head main bodies 15 can be increased. Further, there is no need to increase the thickness of the adhesive between the nozzle surface 39 and the fixing plate 16 to an excessive level and therefore the positions in height direction (perpendicular to the nozzle surface 39) of the nozzle surfaces 39 of the recording head main bodies 15 attached to the fixing plate 16 are aligned at the same level uniquely determined, and since the holder 14 is directly attached to the fixing plate 16, the position of the recording head main bodies 15, in particular the position of the nozzle surfaces 39 in the height direction can be determined on the basis of the height of the joint interface between the fixing plate 16 and the nozzle surface 39 and the height of the holder 14, irrespective of the height of the recording head main bodies 15. Such a configuration allows the positions of the nozzle surfaces 39 of the recording head main bodies 15 in the height direction to be easily managed utilizing the joint interface between the fixing plate 16 and the recording head main bodies 15 as the reference plane, without the need to employ a jig or the like. Consequently, positional fluctuation of the nozzle surface 39 in the height direction among the recording head main bodies 15 can be suppressed.

It is to be noted that the invention is in no way limited to the foregoing embodiment, but may be modified in various manners within the scope of the appended claims.

For example, although four recording head main bodies 15 are accommodated in a single head chamber 22 in the foregoing embodiment, the head chamber may be individually provided for each of the recording head main bodies 15. Alternatively, walls may be provided inside the head chamber 22 of the recording head 2, as partitions between the respective recording head main bodies 15. In addition, the number of recording head main bodies 15 is not limited to four, but may be any number not smaller than one.

Although the piezoelectric actuator 30 of a deflection vibration type is employed as the pressure generator in the foregoing embodiment, a vertical vibration type piezoelectric actuator may be adopted. Additional alternatives of the pressure generator include a heating element that boils the ink by heat so as to generate pressure fluctuation, and an electrostatic actuator that displaces the partition wall of the pressure chamber with an electrostatic force to thereby generate pressure fluctuation.

Further, although the foregoing embodiment refers to the printer 1 including the ink jet recording head exemplifying the liquid ejecting head, the invention is broadly applicable to liquid ejecting apparatuses that include different liquid ejecting heads. For example, the invention is applicable to such a liquid ejecting apparatus that includes a color material ejecting head for manufacturing color filters for a liquid crystal display or the like, an electrode material ejecting head for manufacturing electrodes for an electroluminescence (EL) display or a field emission display (FED), or a bioorganic ejecting head for manufacturing biochips (biochemical elements).

What is claimed is:

1. A liquid ejecting head comprising:
a retention member with a liquid inlet path formed therein so as to introduce a liquid from a liquid storage unit;
a liquid ejecting head main body configured to introduce the liquid into a pressure chamber through a liquid flow path communicating with the liquid inlet path and to dispense droplets of the liquid in the pressure chamber through a nozzle formed on a nozzle surface; and
a fixing plate to which the liquid ejecting head main body is fixed,
wherein the fixing plate includes a first joint portion to which the nozzle surface of the liquid ejecting head main body is attached, and a second joint portion provided on an outer side of the joint interface between the fixing plate and the nozzle surface in the first joint portion and to which the retention member is attached,
the first joint portion includes an opening region through which the nozzle on the nozzle surface of the liquid ejecting head main body is exposed, and a joint region provided around the opening region and attached to a part of the nozzle surface,
the retention member includes a head chamber formed so as to recede from the joint interface with the fixing plate in a direction opposite the fixing plate, and
the retention member and the liquid ejecting head main body are bonded to each other via the respective portions thereof around the liquid inlet path and the liquid flow path, the liquid ejecting head main body being attached to the first joint portion of the fixing plate via the nozzle surface and accommodated in the head chamber, and the second joint portion of the fixing plate and a periphery of the opening of the head chamber of the retention member are attached to each other.

2. The liquid ejecting head according to claim 1,
wherein the first joint portion and the second joint portion are disposed on the same plane.

3. A liquid ejecting apparatus comprising the liquid ejecting head according to claim 1.

4. A liquid ejecting apparatus comprising the liquid ejecting head according to claim 2.
